(19) United States
(12) Patent Application Publication
(10) Pub. No.: US 2023/0411973 A1
(43) Pub. Date: Dec. 21, 2023

(54) Mobile Wireless Audio Transmission System and Charging/Transport Dock

(71) Applicant: Sennheiser electronic GmbH & Co. KG, Wedemark (DE)

(72) Inventors: Jens Buchholz, Eschede (DE); Holger Eilhardt, Langenhagen (DE); Markus Kattner, Hannover (DE); Waldemar Kasianowski, Peine (DE); Manfred Kürbis, Wedemark (DE); Hendrik Millauer, Hannover (DE); Viktor Richert, Hannover (DE); Kolja Windeler, Hambühren (DE); Ralf Kittmann, ZÜRICH (CH); Samira Werner, BUBIKON (CH); Arianna Agudio, ZÜRICH (CH); Eddy Man, Tai Po (HK)

(73) Assignee: Sennheiser electronic GmbH & Co. KG, Wedemark (DE)

(21) Appl. No.: 18/212,459

(22) Filed: Jun. 21, 2023

(30) Foreign Application Priority Data
Jun. 21, 2022 (DE) 102022115410.6

(51) Int. Cl. H02J 7/00; H04B 1/3883; H04R 1/08

(52) U.S. Cl. CPC H02J 7/0042; H04R 1/08; H04B 1/3883

(57) ABSTRACT

A mobile wireless audio transmission system is provided, comprising at least one mobile wireless transmitter for the wireless transmission of audio signals which have been recorded via a microphone in the transmitter or which have been transmitted via an audio input to the transmitter. The transmitter comprises a transmitter rechargeable battery unit. The system further comprises a mobile wireless receiver for the wireless reception of audio signals transmitted wirelessly by the at least one transmitter, wherein the receiver comprises a receiver rechargeable battery unit. The system further comprises a mobile charging/transport dock which comprises at least one transmitter receiving compartment for receiving a transmitter and a receiver receiving compartment for receiving a receiver and a rechargeable battery unit as power supply. The mobile charging/transport dock is configured to charge the transmitter rechargeable battery unit and/or the receiver rechargeable battery unit with energy from the rechargeable battery unit when they are placed in the corresponding receiving compartments.

### CROSS-REFERENCE TO RELATED APPLICATIONS

This application claims priority under 35 U.S.C. § 119(b) to German Patent Application No. 102022115410.6, filed Jun. 21, 2022, the entirety of which is herein incorporated by reference.

### FIELD OF DISCLOSURE

The present invention relates to a mobile wireless audio transmission system and a charging/transport dock.

### BACKGROUND

Wireless audio transmission systems for mobile use, for example, by reporters are known. Here a mobile wireless microphone and a corresponding mobile receiver can be used, which can be fastened to a video camera, for example. Audio signals can be recorded by the wireless microphone and transmitted to the receiver. Thus, for example, a corresponding audio signal can be generated for the video signal produced on the video camera and transmitted to the receiver.

However, such wireless audio transmission systems are frequently cumbersome.

DE 20 2021 102 677 U1 discloses a wireless microphone structure.

### SUMMARY OF THE INVENTION

It is therefore an object of the present invention to provide a wireless audio transmission system which enables improved operability.

This object is achieved by a wireless audio transmission system according to claim 1, by a mobile charging/transport dock according to claim 12 and by a hand microphone according to claim 13.

Thus, a mobile wireless audio transmission system is provided, comprising at least one mobile wireless transmitter for the wireless transmission of audio signals which have been recorded via a microphone in the transmitter or which have been transmitted via an audio input to the transmitter. The transmitter comprises a transmitter rechargeable battery unit.

The system further comprises a mobile wireless receiver for the wireless reception of audio signals transmitted wirelessly by the at least one transmitter, wherein the receiver comprises a receiver rechargeable battery unit. The system further comprises a mobile charging/transport dock which comprises at least one transmitter receiving compartment for receiving a wireless transmitter and a receiver receiving compartment for receiving a wireless receiver and a rechargeable battery unit as power supply. The mobile charging/transport dock is configured to charge the transmitter rechargeable battery unit and/or the receiver rechargeable battery unit with energy from the rechargeable battery unit when they are placed in the corresponding receiving compartments (120).

The at least one wireless transmitter can be ready for operation when it is placed in the transmitter receiving compartment. Thus, the wireless transmitter can also transmit when it is located in the receiving compartment i.e., the transmitter is ready to transmit.

The wireless receiver can be ready for operation when it is placed in the receiver receiving compartment. Thus, the wireless receiver can also receive when it is located in the receiving compartment, i.e., the receiver is ready to receive

The receiver can receive two audio channels from two transmitters so that a two-channel reception is possible.

The charging/transport dock can have two transmitter receiving compartments.

The charging/transport dock optionally has adapter receiving compartments for receiving various adapters.

The wireless transmitter optionally has a transmitter memory for storing recorded audio signals.

The wireless transmitter can have a microphone and/or an audio input and a clip-on unit by means of which the transmitter can be fastened to an item of clothing of a user. A wireless clip-on microphone can thus be made possible.

The at least one wireless transmitter can transmit an audio signal wirelessly via a first wireless transmission section to the wireless receiver and/or via a second wireless transmission section to an external smart device.

The wireless receiver can have a data connection by means of which the wireless receiver can be coupled to a video camera or a smart phone or another electronic device for the transmission of audio signals and/or video signals.

The charging/transport dock can have a data connection by means of which an audio signal from the wireless transmitter in the transmitter receiving compartment or an audio signal stored in a memory of the charging/transport dock can be output.

Furthermore, a mobile charging/transport dock is provided comprising at least one transmitter receiving compartment for receiving a wireless transmitter, a receiver receiving compartment for receiving a wireless receiver and a rechargeable battery unit as power supply. The charging/transport dock is configured to charge the transmitter rechargeable battery unit and/or the receiver rechargeable battery unit with energy from the rechargeable battery unit when they are placed in the corresponding receiving compartments.

Furthermore a hand microphone is provided comprising a microphone handle in the form of a charging/transport dock with a transmitter receiving compartment for receiving a wireless transmitter and a rechargeable battery unit as power supply. Furthermore, a wireless transmitter is provided for wireless transmission of audio signals which have been recorded via a microphone in the wireless transmitter or which have been transmitted via an audio input to the transmitter. The wireless transmitter has a transmitter rechargeable battery unit as power supply and can be placed in the transmitter receiving compartment of the dock, wherein the transmitter can transmit the audio signals wirelessly when it is located in the receiving compartment and also when it is not located in the receiving compartment.

A mobile charging/transport dock is further provided. The mobile charging/transport dock has a housing and a receiving compartment for a transmitter and a receiving compartment for a receiver. Both the transmitter and the receiver can be charged by the charging dock when they are placed in the corresponding receiving compartment. To this end, the charging dock has a rechargeable battery unit. The energy of this rechargeable battery unit can be used to recharge the battery/rechargeable batteries in the transmitter and/or the receiver. The charging dock has a charging connection (e.g. USB-C) in order to charge the rechargeable battery unit in the charging dock and/or the rechargeable battery units in the transmitter and/or the receiver.

Optionally the data connection and the charging connection can be configured as a combined data/charging connection.

Optionally the charging dock can have a memory for storing audio signals. The charging dock can further optionally have an audio output and/or a headphone output to be able to output stored audio signals.

Optionally the charging dock has adapter receiving compartments for receiving various adapters. Thus, various adapters for example for smart phones and video cameras can be placed in the charging/transport dock. Thus, all the elements required for a mobile wireless audio transmission (namely at least one transmitter and one receiver) can be transported in the charging/transport dock. Furthermore, adapters can also be transported in the charging/transport dock. Accordingly, for a mobile ad hoc wireless audio transmission a user only needs the charging/transport dock in which at least one transmitter is placed in a corresponding receiving compartment and a receiver is placed in a corresponding receiving compartment. Due to the rechargeability by the charging dock, a mobile use of a mobile wireless audio transmission system with a long operating time can be ensured.

Furthermore, a mobile wireless audio transmission system can be provided. This mobile wireless audio transmission system has at least one mobile transmitter with a microphone and a rechargeable battery unit. The audio transmission system further comprises a mobile receiver with a rechargeable battery unit. The receiver can wirelessly receive the audio signals transmitted by the transmitter and optionally store them temporarily in a memory. The transmitter and the receiver can thus enable a mobile and wireless audio transmission section.

The transmitter can comprise a microphone and optionally an audio input. Optionally the transmitter can have a clip-on unit by means of which the transmitter can be fastened to the microphone on an item of clothing of a user in order to be able to record the audio signals of the user. A clip-on microphone can thus be made possible.

The receiver can have a data connection by means of which it can be coupled in or on a video camera or a smart phone or another electronic device. Via this interface the receiver can output the received audio signals externally, i.e. to the smart phone, the camera etc.

Since both the mobile transmitter and also the mobile receiver have their own power supply, a mobile wireless and ad hoc use of a wireless audio transmission system is readily possible.

The charging/transport dock and the transmitter and the receiver are thus matched to one another so that the transmitter and the receiver can be used when they are located in the corresponding receiving compartments.

Furthermore, a hand-held microphone or a hand microphone is provided in which a housing of the charging/transport dock serves as microphone handle. In this case, a transmitter with a microphone is placed in one of the transmitter receiving compartments. Thus, the transmitter with the appurtenant microphone and the charging/transport dock as microphone handle together form a hand-held microphone.

The audio signals recorded by the microphone can be transmitted wirelessly via the transmitter and be received wirelessly by the receiver, for example. Alternatively to this, the audio signals recorded by the microphone can be stored in a memory in the transmitter, in a memory in the receiver or in a memory in the charging/transport dock. The interface inside the transmitter receiving compartment can serve to output both a supply voltage to the transmitter and also enable a (bidirectional) data communication. Thus, the audio signals recorded by the microphone can be output to the charging/transport dock where they can be stored in the memory. Furthermore, optionally by means of the interface, a switch-on pulse can be transmitted, for example, from a switch-on button of the charging dock to the transmitter so that the transmitter can also be activated.

The stored audio signals in the transmitter or the stored audio signals in the charging dock can be output via an audio output of the charging dock. Optionally the stored audio signals can be output via an audio output at the receiver. When the receiver is located in the charging/transport dock, the stored audio signals can be output in a wired manner via a data connection to the receiver. Alternatively the stored signals can be transmitted wirelessly via the transmitter to the receiver and output at the audio output of the receiver.

A mobile wireless audio transmission system comprises a charging/transport dock, at least one transmitter with a microphone and a receiver. The charging/transport dock has a transmitter receiving compartment for a transmitter and a receiver receiving compartment for a receiver. The charging dock has a rechargeable battery unit by means of which a rechargeable battery unit in the transmitter and/or the receiver can be charged when the transmitter and/or the receiver is placed in the corresponding receiving compartment.

Preferably the mobile wireless audio transmission system has two transmitters which can each be placed in a transmitter receiving compartment in the charging/transport dock.

The transmitter can transmit the audio signal directly and wirelessly to the receiver. The transmitter can transmit the audio signal via the data connection to the charging dock.

The transmitter can optionally transmit an audio signal wirelessly to the receiver via a first data transmission section. The transmitter can optionally transmit an audio signal wirelessly to a smart device such as a smart phone via a second wireless transmission section. These two wireless transmission sections can have different transmission protocols.

The transmitter can be configured as a mobile transmitter with its own power supply, a microphone and a wireless transmitter. The microphone is at the first end and the data/charging connection can be provided at a second opposite end.

The receiver can be configured as a mobile receiver with its own power supply and a wireless receiver and a charging/data connection. The display can be provided at one end and the charging connection can be provided at an opposite end.

Further embodiments of the invention are the subject of the dependent claims.

### BRIEF DESCRIPTION OF THE DRAWINGS

Advantages and exemplary embodiments of the invention are explained in detail hereinafter with reference to the drawings.

FIG. 1 shows a schematic diagram of a mobile wireless audio transmission system,

FIG. 2 shows a schematic diagram of a charging/transport dock,

FIG. 3 shows a further perspective view of a charging/transport dock,

FIG. 4 shows a schematic diagram of a mobile wireless audio transmission system,

FIG. 5 shows a schematic diagram of a mobile wireless audio transmission system,

FIG. 6 shows a schematic diagram of a mobile wireless audio transmission system,

FIG. 7 shows a further schematic diagram of a mobile wireless audio transmission system,

FIG. 8 shows a schematic diagram of a mobile wireless audio transmission system,

FIG. 9 shows a schematic diagram of a mobile wireless audio transmission system,

FIG. 10 shows a schematic diagram of a mobile wireless audio transmission system,

FIG. 11 shows a schematic diagram of a side of a transmitter for a mobile wireless audio transmission system,

FIG. 12 shows a schematic diagram of a side of a receiver for a mobile wireless audio transmission system

FIG. 13 shows a schematic diagram of a charging/transport dock for a mobile wireless audio transmission system.

### DETAILED DESCRIPTION

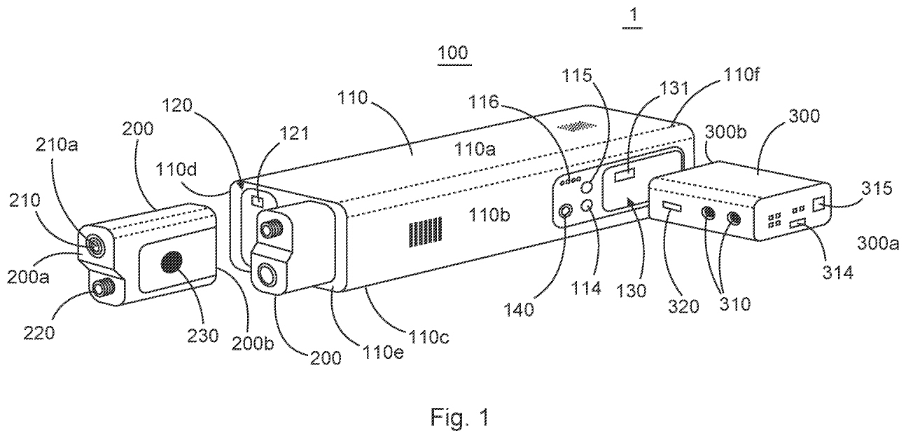

FIG. 1 shows a schematic diagram of a mobile wireless audio transmission system. The mobile wireless audio transmission system 1 comprises at least one mobile transmitter 200 and at least one mobile receiver 300. Optionally a charging/transport dock 100 is provided. The charging/transport dock 100 comprises a housing 110 with at least one transmitter receiving compartment 120 for receiving at least one transmitter 200. Further provided in the housing 110 of the charging/transport dock 100 is a receiver receiving compartment 130 which serves to receive the receiver 300.

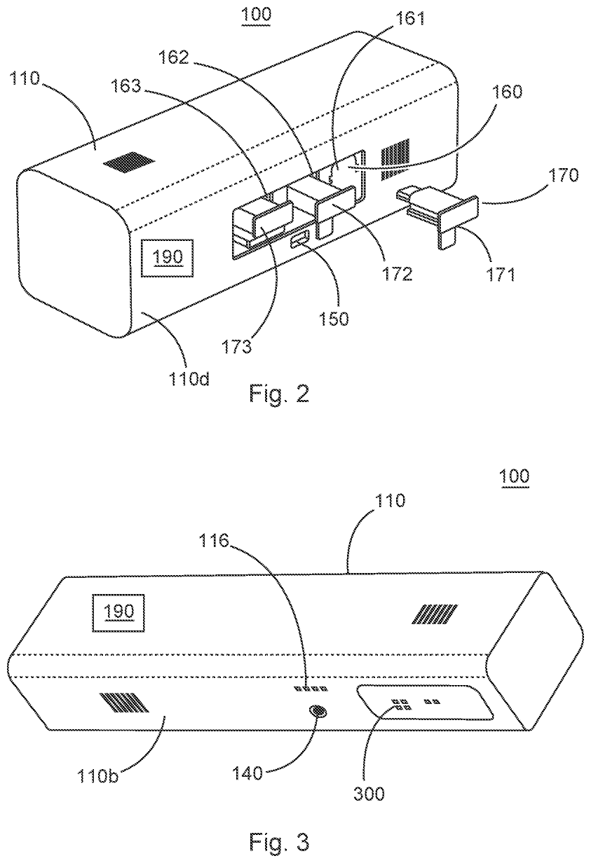

FIG. 2 shows a schematic diagram of a charging/transport dock. FIG. 2 shows the side of the charging/transport dock not shown in FIG. 1.

FIG. 3 shows a further perspective view of a charging/transport dock from FIG. 1. FIG. 3 shows the charging/transport dock 100 wherein the mobile receiver 300 has been completely received in the receiver receiving compartment 130.

The charging/transport dock 100 thus comprises a housing 110 with at least one transmitter receiving compartment 120 and a receiver receiving compartment 130. First charging contacts 121 can be provided in the transmitter receiving compartment 120 by means of which a power supply unit or transmitter rechargeable battery unit 240 of the transmitter 200 can be charged. Second charging contacts 131 can be provided in the receiver receiving compartment 130 which serve to charge the power supply unit or the receiver rechargeable battery unit 340 of the receiver 300 when the receiver 300 is placed in the receiver receiving compartment 130.

The charging/transport dock 100 can have an audio output 140 and a data/charging connection 150. Furthermore, at least one adapter receiving compartment 160 can be provided in the housing 110 of the charging/transport dock 100. For example, a first, second and third adapter receiving compartment 161, 162, 163 can be provided. These receiving compartments 160-163 serve to receive adapters 170, namely a first adapter 171, a second adapter 172 and a third adapter 173. The first adapter 171 can, for example, comprise an adapter for Apple iPhones. The second adapter 172 can be an adapter for other smartphones. The third adapter 173 can be an adapter for a video camera.

Optionally the charging/transport dock can have a memory 180 by means of which audio signals can be stored. The charging/transport dock 100 further comprises a rechargeable battery unit 190 as power supply unit. The capacity of the rechargeable battery unit 190 is preferably configured so that two transmitters 200 and the receiver 300 can each be charged at least twice.

The housing 110 of the charging dock 100 has a first, second, third and fourth side 110a, 110b, 110c, 110d. Furthermore, the housing has a first and second front side 110e, 110f. The first and third side 110a, 110c as well as the second and fourth side 110b, 110d lie parallel to one another. The first and second front side 110e, 110f lie at opposite ends of the housing 110.

The transmitter receiving compartment 120 is provided on the first front side 110e. The receiver receiving compartment 130 is provided on the second side 110b. The data/charging connection 150 and the adapter receiving compartment 160 can be provided on the fourth side 110d.

The housing 110 of the charging dock 100 is preferably cuboid with two front sides whose area is smaller than the area of the remaining sides of the cuboid.

Optionally the length of the housing 110 (i.e. from the first to the second front side) is between 10 and 20 cm, for example, 15 cm. The first and second front sides are optionally substantially rectangular in their cross-section with a first side length of between 3 and 7 cm, for example, 4 cm and with a second side length of between 3 and 5 cm, for example, 4 cm.

Thus, a cross-section of the housing 110 is so large that a hand of a user can substantially embrace the housing, can embrace at least three sides.

Alternatively, the housing 110 can be provided such that the cross section as well as the two front sides 110e, 110f are round or oval. The diameter of the cross section can be between 3 cm and 7 cm. It is important that the diameter of the cross section is substantially smaller than the length of the housing, such that a distinct orientation or alignment is present, when the housing 110 together with the transmitter 200 is used as a grip of a handheld microphone.

The transmitter 200 has a microphone 210, optionally an audio output 220 and an optional clip-on unit 230. The clip-on unit 230 serves to enable attachment of the transmitter to an item of clothing of a user to enable a wireless clip-on microphone.

The transmitter 200 further comprises a transmitter rechargeable battery unit 240 as power source for the wireless transmitter 200, optionally a transmitter memory 250 for storing audio signals, a transmitter data/charging connection 260 for direct charging of the transmitter and transmitter charging contacts 270. By means of the transmitter charging contacts 270 the transmitter 200 can be charged by the charging/transport dock 100 when the transmitter 200 is placed in the transmitter receiving compartment 120. The transmitter data/charging connection 260 can be used for charging the transmitter rechargeable battery unit (independently of the charging dock) and/or for exchange of audio signals. The transmitter data/charging connection 260 can optionally be implemented as a USB-C connection.

The transmitter 200 has a first end or a first front side 200a and a second end or a second front side 200b which is opposite to the first end or first front side 200a. At the second end 200d, transmitter charging contacts 270 are provided and the microphone 210 is provided at the first end 200a such that the charging contacts 270 and the microphone are arranged at opposite sides. When the mobile transmitter 200 is placed in the receiving compartment, the transmitter 200 is then placed with the second end 200b first (and therefore with the transmitter charging contacts 270 first) in the receiving compartment 120. Here the transmitter charging contacts 270 comes in contact with the charging contacts 121 of the receiving compartment 120. The first end 200a can optionally project over the first front side 110e of the charging dock. In any case, an opening 210a is provided at the first end 200a through which an audio signal can penetrate to the microphone 210 where it can be recorded. Thus, the opening 210a with the appurtenant microphone is located on the outwardly directed or free end 200a of the charging dock 100. The opening 210a serves as input for the microphone 210 and the opening 210a is aligned in the same direction as the first front face 110e of the housing 110 such that the housing 110 can be used as a grip for a handheld microphone.

The receiver 300 can have at least one audio connection 310, a data/charging connection 320 and a receiver rechargeable battery unit 340. Furthermore, the receiver can have a receiver charging connection 350 and charging contacts 360. The receiver 300 can be charged directly by means of the receiver charging connection 350. By means of the charging contacts 360 the receiver 300 can be charged by the charging/transport dock 100 when the receiver 300 is placed in the receiver receiving compartment 130.

Optionally the receiver 300 can have a receiver memory 330 which is used to store audio signals that the receiver 300 has received.

The charging dock 100 for example has a receiving compartment 130 for a mobile receiver 300 on the second side 110b. The receiver has a first and second end 300a, 300b. A charging connection 350 and charging contacts 360 can be provided at the second end 300b. If the receiver is placed with the second end 300b at the front in the receiving compartment 130, the charging connection 350 of the receiver 300 is then in contact with the charging contact 131 in the receiving compartment. A display 315 of the receiver can be placed on the first side 300a so that the display always points outwards when the receiver is placed in the receiving compartment.

Actuating elements 115, an audio output and optionally an on button can be provided on the second side 110b of the housing 110.

This is advantageous since the display 315 is thus visible when the receiver 300 is placed in the receiving compartment 130 and the housing 110 of the charging dock is used as a microphone handle.

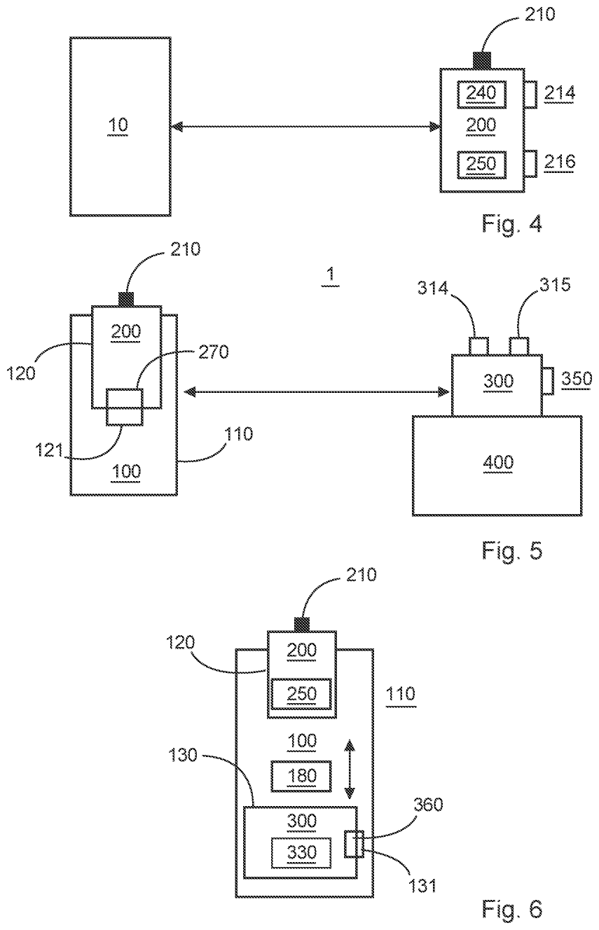

FIG. 4 shows a block diagram of a mobile wireless audio transmission system. In FIG. 4 a smart device such as a smartphone 10 can be coupled wirelessly to a transmitter 200. The transmitter 200 has a microphone 210, a transmitter rechargeable battery unit 240 and optionally a transmitter memory 250. The audio signals recorded by the microphone 210 are transmitted wirelessly by means of the transmitter 200 to the smart device 10, where the received audio signals can be stored. For example, the stored audio signals can be mixed with a video signal recorded by the smart device 10. The wireless communication between the smart device 10 and the transmitter 200 can, for example, be based on a Bluetooth protocol, in particular Bluetooth 5.2. In this case, the receiver 300 is not required since the smart device 10 takes over the function of the receiver.

FIG. 5 shows a block diagram of a mobile wireless audio transmission system. FIG. 5 shows a mobile wireless audio transmission system 1 in which a receiver 300 is, for example, coupled to a camera 400. The transmitter 200 with the microphone 210 is placed in a transmitter receiving compartment 120 of the charging/transport dock 100. The audio signals recorded by the microphone 210 are transmitted wirelessly by the transmitter 200 to the receiver 300 which can then relay the received audio signals to the camera 400. In this example, the transmitter 200 with the microphone 210 is at least partially placed in the housing 110 of the charging/transport dock 100. The housing 110 of the charging/transport dock 100 can thus be used as a microphone handle. The combination of the charging/transport dock 100 with the inserted transmitter 200 with the microphone 210 can thus be used as a hand-held microphone or hand microphone.

FIG. 6 shows a block diagram of a mobile wireless audio transmission system. FIG. 6 shows a mobile wireless audio transmission system in which a transmitter 200 with a microphone 210 is placed in a transmitter receiving compartment 130. The microphone 210 can then record an audio signal. This audio signal can then be stored, for example, in the transmitter memory 250, the memory 180 of the charging/transport dock 100 and/or in the receiver memory 330. In this case, no wireless transmission by the transmitter 200 takes place. The transmitter 200 together with the charging/transport dock 100 thus serves as a microphone which stores the recorded audio signals. The stored audio signals can then be processed in a subsequent step.

By placing the wireless transmitter 200 and/or the wireless receiver 300 in the corresponding transmitter receiving compartment 120 or the receiver receiving compartment 130, these can be charged during operation. In other words, the charging/transport dock 100 transmits energy from the rechargeable battery unit 190 to the rechargeable battery units 240 of the transmitter and the rechargeable battery unit 340 of the receiver. The transmitter 200 and/or the receiver 300 are therefore charged.

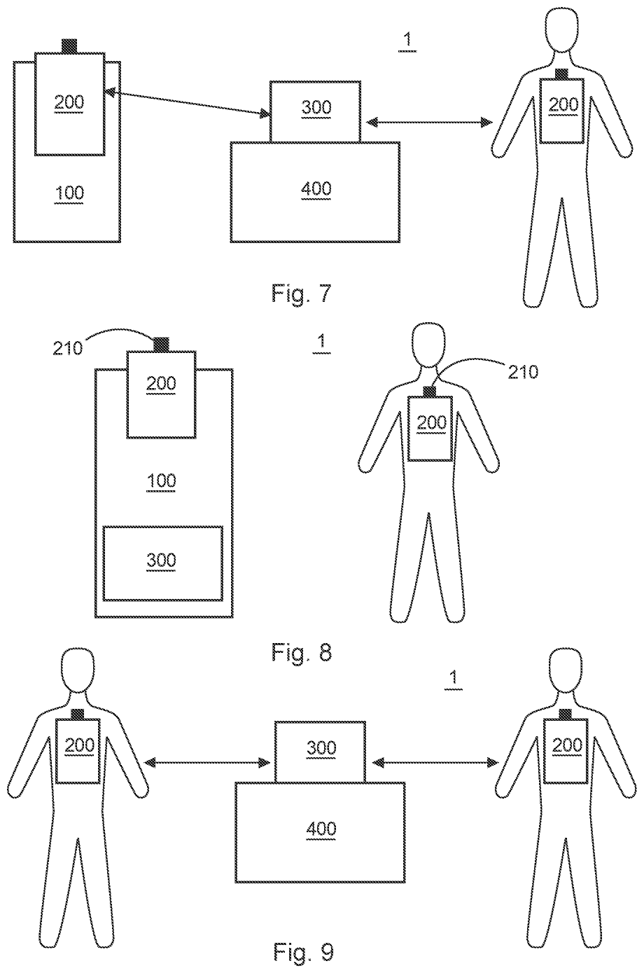

FIG. 7 shows another schematic diagram of a mobile wireless audio transmission system. The mobile wireless audio transmission system 1 has two transmitters 200 (each with a microphone or an audio output), a charging/transport dock 100, a receiver 300 and a camera 400. The receiver 300 is coupled to the camera 400 and receives audio signals from the transmitters 200 and relays the received audio signals to the camera for further processing. A transmitter 200 is placed in a transmitter receiving compartment 120 of the charging/transport dock 100. A further transmitter 200 can be fastened as a clip-on microphone, for example, by means of the clip-on unit 230 to an item of clothing of a user. The two transmitters 200 can then transmit a corresponding recorded audio signal to the receiver 300. Thus, a mobile wireless audio transmission system 1 is provided with two channels. Such a situation can be required, for example, when an interview is to be conducted. In this case, the transmitter 200 as a clip-on microphone can be attached to an item of clothing of the person to be interviewed whilst the interviewer can use the hand-held microphone consisting of the charging/transport dock 100 with a transmitter 200 having a microphone 210.

FIG. 8 shows a schematic diagram of a mobile wireless audio transmission system. FIG. 8 shows an example of a mobile wireless audio transmission system 1 in which two transmitters (each having a microphone 210) are provided. A transmitter 200 can be placed in the charging/transport dock 100 so that the charging/transport dock 100 together with this transmitter can be used as a hand-held microphone. A second transmitter 200 can be attached as a clip-on microphone, for example, by means of the clip-on unit 230 to an item of clothing of a user. Optionally the receiver 300 can be placed in a receiver receiving compartment 130 of the charging/transport dock 100.

Thus, a two-channel mobile wireless audio transmission system 1 is again provided. The audio signals recorded by the transmitter 200 in the charging/transport dock 100 can be stored in the transmitter 200, the charging/transport dock 100 and/or the receiver 300 without requiring a wireless transmission beforehand. The audio signals recorded by the further transmitter 200 can be transmitted wirelessly to the receiver 300. The audio signals received by the receiver 300 can be stored in the receiver 200 and/or in the charging/transport dock 100 and be provided for further processing together with the other audio signals.

FIG. 9 shows a schematic diagram of a mobile wireless audio transmission system. A two-channel mobile wireless audio transmission system 1 is again provided in FIG. 1. The system has two transmitters 200 each having a microphone 210. The transmitters 200 are fastened, for example, by means of the clip-on units 230 to an item of clothing of a user and can each recorded an audio signal and transmit it wirelessly to the receiver 300. The receiver 300 can be coupled to a smart phone 10 or a camera 400. This coupling can be accomplished, for example, by means of one of the adapters 170 or wirelessly.

The receiver 300 can store the audio signals transmitted by the two transmitters 200 and/or relay them to the camera 400 or the smart device 10. The receiver can thus receive a stereo signal and relay it if necessary.

FIG. 10 shows a schematic diagram of a mobile wireless audio transmission system. A mobile wireless audio transmission system 1 is shown in FIG. 10. The system 1 for example has two transmitters 200 each with a microphone 210. The transmitters 200 with the microphones 210 record and audio signal and transmit this audio signal wirelessly to the receiver 300 so that a two-channel mobile wireless audio transmission system can be provided. The receiver 300 can relay the recorded audio signals to a computer such as, for example, a laptop, a tablet etc.

The connection between the receiver 300 and the computer 500 can be accomplished in a wired manner by means of an adapter 170 or wirelessly.

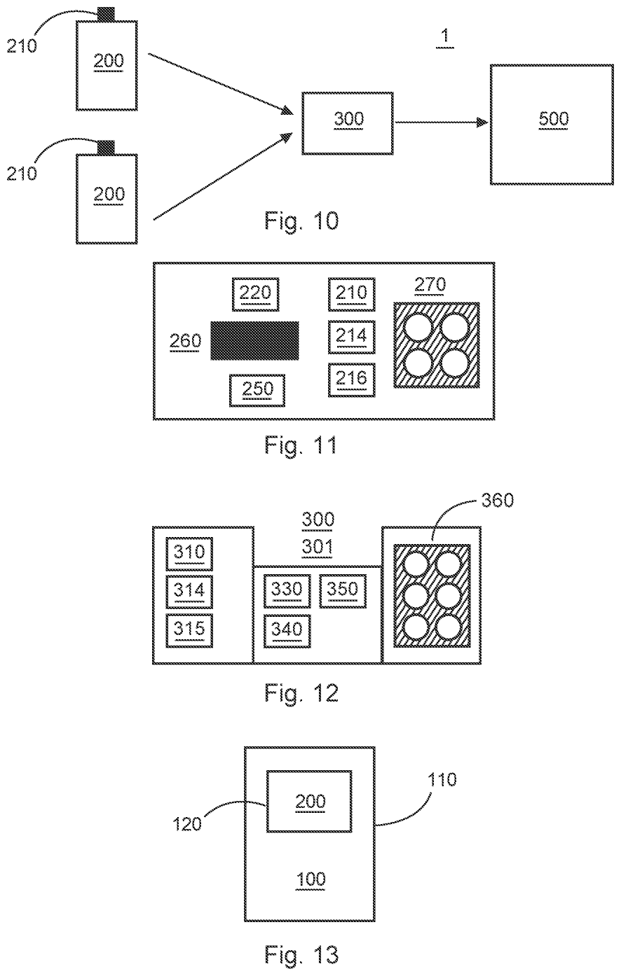

FIG. 11 shows a schematic diagram of a side of a transmitter for a mobile wireless audio transmission system. The transmitter 200 can have a data/charging connection 260 as well as charging contacts 270. The data/charging connection 260 can, for example, be provided in the form of a USB-C socket. By means of this connection 260, the transmitter 200 can optionally be charged independently of the charging dock. Furthermore, data or audio signals which are stored, for example, in the transmitter 200 in the memory unit 250 can be transmitted by means of this connection 260. Alternatively to this, the audio signals recorded by the transmitter 200 can be transmitted directly by means of the connection 260.

FIG. 12 shows a schematic diagram of a side of a receiver for a mobile wireless audio transmission system. The receiver has charging contacts 360 which serve to electrically couple to corresponding contacts in the receiver receiving compartment 130 in order to enable a charging of the receiver by the charging dock.

The receiver 300 can have an audio output 310, a switch-on button 340, a display 315, a receiver memory 330, a receiver rechargeable battery unit 340, a data/charging connection 350 and/or charging contacts 360. Furthermore the receiver 300 can optionally have a recess 301 for an adapter. The recess 301 can further be provided in order to use an audio and/or headphone output of the inserted receiver. Audio signals can thus be output.

FIG. 13 shows a schematic diagram of a charging/transport dock for a mobile wireless audio transmission system. Optionally the transmitter receiving compartment 120 is configured in such a manner that the transmitter 200, when introduced into the receiving compartment, ends flush with the housing 110 of the charging/transport dock.

The same applies to the receiver 300 and the receiver receiving compartment 130.

The wireless transmission between the transmitter 200 and the receiver 300 according to the above examples can be accomplished on a Bluetooth low energy protocol, for example, at 2.4 GHz. The transmitter 200 can further be able to communicate directly with a smart device 10 wirelessly for example, based on a Bluetooth protocol. A different wireless transmission section is also possible.

Optionally the transmitter 200 can produce a wireless transmission section with the receiver which differs from a wireless transmission section between a transmitter and a smart device.

Optionally a wireless transmission between a smart device and a transmitter 200 can be accomplished merely via one channel. Another channel for a wireless transmission can then be accomplished between a further transmitter 200 and the receiver. The recorded audio signals can then be combined subsequently.

Optionally the wireless transmission section between the transmitters 200 and the receiver 300 can have a low latency of 30 ms at most.

The receiver 300 can output a received audio signal via an (analogue) audio output 310 or via the data/charging connection (e.g. USB-C).

According to one aspect of the present invention, the transmitter 200 has a microphone. The microphone 210 can comprise an omnidirectional microphone capsule. Optionally the connection 220 can be an analogue input with a thread for external microphones. The audio signals recorded by an external microphone can be relayed via the audio input 220 to the transmitter which can then transmit the audio signal wirelessly.

Optionally the transmitter 200 can relay either the signals received via the microphone 210 or via the audio input 220.

According to one aspect of the present invention, the transmitter 200 and the receiver 200 can be locked in by pressing into the corresponding receiving compartments 120, 130. In this case, a spring mechanism with locking can be provided in order to hold the transmitter and the receiver in position. Optionally the charging/transport dock 100 can have actuating elements 115 by means of which the transmitter and/or the receiver can be released separately from the locking.

The dimensions of the housing 110 of the charging/transport dock 100 have a length between 160 and 180 mm. The width can be between 40 and 50 mm and the height can be between 50 and 60 mm.

The charging/transport dock 100 has an on button 114, actuating elements 115 and a plurality of feedback LEDs 116. The on button 114 is used to switch on or wake up the charging/transport dock 100 and all the transmitters 200 or receivers 300 located therein. The charging state can be displayed by means of the LEDs 116. Optionally an audio recording of a transmitters located in the transmitter receiving compartment 120 can be started by means of the actuating element 114.

Optionally three actuating elements 115 are provided, wherein two are assigned to the two transmitter receiving compartments 120 and one is assigned to the receiver receiving compartment 130.

The LEDs 116 can be used to display the charging state or a diagram of the charging process.

A transmitter 200 can optionally have two buttons and three feedback LEDs. This is advantageous because the transmitter (without receiver) can thus be used directly with a smart phone. The transmitter can have a switch-on button 214 which is used for switching on and off the transmitter. A gain stage on the transmitter can be adjusted by means of the on button 214. Furthermore, a pairing mode can be activated. By means of the on button 214 an audio recording of the transmitter can be started or stopped.

The LEDs 216 serve to display the charging state, display the set gain level, display the connection quality of the wireless transmission section (to the receiver or smart phone) and to display whether an audio recording is carried out by the transmitter.

When the transmitter 200 is placed in the receiving compartment 120, optionally the on button and the LEDs 216 cannot be reached.

The receiver 300 can have an on button 314 and a touch display 315. The receiver can be switched on and off by means of the on button 314. Furthermore the touch display can thus be blocked or unblocked.

The touch display 315 is used to operate and display all functions of the transmitter and the receiver.

### REFERENCE LIST

1 Wireless audio transmission system
10 Smart phone
15 Actuating elements
100 Charging/transport dock
110 Housing
110a First side
110b Second side
110c Third side
110d Fourth side
110e First front side
110f Second front side
114 On button
115 Actuating elements
116 LEDs
120 Transmitter receiving compartment
121 Charging contacts
130 Receiver receiving compartment
131 Charging contacts
140 Audio output
150 Data charging connection
160 Adapter receiving compartments
161 First adapter receiving compartment
162 Second adapter receiving compartment
163 Third adapter receiving compartment
170 Adapter
171 First adapter
172 Second adapter
173 Third adapter
180 Memory
190 Rechargeable battery unit
200 Transmitter
200a First front side
200b Second front side
201 Hole
210 Microphone
214 On button
216 LEDs
220 Audio input
230 Clip-on unit
240 Transmitter rechargeable battery unit
250 Transmitter memory
260 Transmitter data/charging connection
270 Transmitter charging contacts
300 Receiver
300a First end
300b Second end
301 Recess
310 Audio connection
314 On button
315 Display
320 Data/charging connection
330 Receiver memory
340 Receiver rechargeable battery unit
350 Receiver charging connection
360 Charging contacts
400 Camera
500 Computer

1. A mobile wireless audio transmission system, comprising:
at least one mobile wireless transmitter for the wireless transmission of audio signals which have been recorded via a microphone in the wireless transmitter or which have been transmitted via an audio input to the wireless transmitter, wherein the wireless transmitter comprises a transmitter rechargeable battery unit,
a mobile wireless receiver for the wireless reception of audio signals transmitted wirelessly by the at least one wireless transmitter, wherein the wireless receiver comprises a receiver rechargeable battery unit and
a mobile charging/transport dock which comprises at least one transmitter receiving compartment for receiving a wireless transmitter, a receiver receiving compartment for receiving a wireless receiver and a rechargeable battery unit as power supply,
wherein the mobile charging/transport dock is configured to charge the transmitter rechargeable battery unit and/or the receiver rechargeable battery unit with energy from the rechargeable battery unit when they are placed in the corresponding receiving compartments.

2. The mobile wireless audio transmission system according to claim 1, wherein the at least one transmitter is ready to transmit when it is placed in the transmitter receiving compartment,
wherein the microphone of the mobile wireless transmitter can freely record audio signals from outside in the inserted state of the transmitter.

3. The mobile wireless audio transmission system according to claim 1, wherein
the receiver is ready to receive when it is placed in the receiver receiving compartment, wherein the wireless receiver has a display which can be seen from outside in the inserted state of the receiver.

4. The mobile wireless audio transmission system according to claim 1, wherein
the receiver can receive two audio channels from two transmitters.

5. The mobile wireless audio transmission system according to claim 1, wherein
the charging/transport dock has two transmitter receiving compartments.

6. The mobile wireless audio transmission system according to claim 1, wherein the charging/transport dock has adapter receiving compartments for receiving various adapters.

7. The mobile wireless audio transmission system according to claim 1, wherein the transmitter has a transmitter memory for storing recorded audio signals.

8. The mobile wireless audio transmission system according to claim 1, wherein
the wireless transmitter has a microphone and/or an audio input and a clip by means of which the wireless transmitter can be fastened to an item of clothing of a user.

9. The mobile wireless audio transmission system according to claim 1, wherein
the at least one wireless transmitter can transmit an audio signal wirelessly to the receiver and/or an external smart device.

10. The mobile wireless audio transmission system according to claim 1, wherein
the wireless receiver has a data connection by means of which the wireless receiver can be coupled to an external video camera or an external smart device or another electronic device for transmission of audio signals.

11. The mobile wireless audio transmission system according to claim 1, wherein
the charging/transport dock has a data connection by means of which an audio signal can be output from the wireless transmitter in the transmitter receiving compartment or an audio signal stored in a memory of the charging/transport dock can be output.

12. A mobile charging/transport dock comprising:
at least one transmitter receiving compartment for receiving a wireless transmitter,
a receiver receiving compartment for receiving a wireless receiver and
a rechargeable battery unit as power supply,
wherein the charging/transport dock is configured to charge the transmitter rechargeable battery unit and/or the receiver rechargeable battery unit with energy from the rechargeable battery unit when they are placed in the corresponding receiving compartments.

13. A hand microphone comprising:
a microphone handle in the form of a charging/transport dock having a transmitter receiving compartment for receiving a wireless transmitter and a rechargeable battery unit as power supply and
a wireless transmitter for the wireless transmission of audio signals which have been recorded via a microphone in the transmitter or which have been transmitted via an audio input to the transmitter,
wherein the wireless transmitter has a transmitter rechargeable battery unit as power supply and can be placed in the transmitter receiving compartment,
wherein the wireless transmitter can transmit the audio signals wirelessly when it is located in the transmitter receiving compartment and when it is not located in the transmitter receiving compartment.

14. A mobile wireless audio transmission system according to claim 1, wherein
the mobile charging/transport dock comprises a first front side and a second front side, wherein a length of the mobile charging/transport dock between the first and second front side is between 10 cm to 20 cm,
wherein the first and second front side comprises side lengths between 3 cm and 7 cm, such that the charging/transport dock has a longitudinal shape, and
wherein the at least one transmitter receiving compartment is arranged at the first front face such that the charging/transport dock can be used as grip of a handheld microphone, when the wireless transmitter is placed into the transmitter receiving compartment and
wherein the transmitter/receiving compartment comprises charging contacts,
wherein the wireless transmitter comprises a first end and a second end opposite to the first end, and wherein the wireless transmitter comprises transmitter charging contacts,
wherein the microphone is arranged at the first end of the wireless transmitter and the transmitter charging contacts are arranged at the second end of the wireless transmitter, such that an input of the microphone is pointing in the same direction as the first front side of the charging/transport dock, when the wireless transmitter is placed into the transmitter receiving compartment.
